(19) United States
(12) Patent Application Publication
(10) Pub. No.: US 2005/0154978 A1
(43) Pub. Date: Jul. 14, 2005

(54) Programmatic creation and access of XML documents

(75) Inventors: Jordi A. Albornoz, Arlington, MA (US); Lee Feigenbaum, Brookline, MA (US); Dennis A. Quan JR., Quincy, MA (US)

Correspondence Address: FLEIT, KAIN, GIBBONS, GUTMAN, BONGINI;& BIANCO P.L., ONE BOCA COMMERCE CENTER, 551 NORTHWEST 77TH STREET, SUITE 111, BOCA RATON, FL, 33487, US

(73) Assignee: INTERNATIONAL BUSINESS MACHINES CORPORATION

(21) Appl. No.: 10/754,301

(22) Filed: Jan. 9, 2004

(51) Int. Cl. G06F 15/00

(52) U.S. Cl. 715/513

(57) ABSTRACT

A method and system is provided for allowing efficient creation of data structures that correspond to data formats specified by content models specified within XML schemas. The data in these data structures is produced as XML documents that conform to those XML schema. Programs written in dynamic programming languages, such as JavaScript, create and instantiate object classes that conform to one or more pre-existing XML schemas. These object classes provide an application program interface (API) for application programs to manipulate data via exposed data structures and methods. Application programs are able to access exposed data structures through conventional programming methods. After the application program has completed manipulation of data within the instantiated data classes, the data is then produced as an XML document that conforms to the XML schema.

### BACKGROUND OF THE INVENTION

1. Field of the Invention

This invention relates to computer software and more specifically to computer software execution environments.

2. Description of Related Art

Many applications store data in a structured format that is designed for easy exchange among multiple application programs. Storing data in extensible Markup Language (XML) documents is one technique for storing data in such structured, easily exchangeable formats. Data is able to be stored in XML documents with or without a predefined structure. An XML schema document can be used to define the structure of data stored in XML documents. An XML schema document is itself an XML document that specifies the structure and/or content model of other XML documents.

Computer programs typically use generic, standardized APIs (Application Programming Interfaces) to manipulate data within XML documents. Examples of such generic, standardized APIs include the DOM (Document Object Model) API, which is defined by the Worldwide Web Consortium, and the SAX (Simple API for XML) API. Manipulating XML data with these generic APIs is straightforward when there is no constraint on the structure of the data in the XML document and the API therefore requires no knowledge of the data structure. However, XML data can be, and often is, constrained by an XML schema document. While a generic API manipulates XML documents in terms of nodes and children, an XML schema defines custom XML data structures, such as structures that contain information characterized as a Person, an Address, or a PurchaseOrder.

Using a generic API to manipulate data within structured XML documents creates several problems. Such usage generally requires overly verbose and complex software code. The software developer writing software code that uses a generic API is required to properly implement the data structure by explicit processing within the code itself. This requires the developer to know the proper structure and manually implement that structure within the developed application program code. Generic APIs further do not aid the developer at all in the creation of properly structured documents, such as by verifying compliance of the created data structure with the XML schema. Furthermore, since the generic APIs do not themselves incorporate the structure defined by an XML schema, software code using these generic APIs is easily subject to coding errors by the developer. Such errors lead to the creation of an XML document that does not conform syntactically to the XML schema.

A need therefore exists for a way to create and manipulate structured data in XML documents from within programs in a way that automatically incorporates XML schema data so as to properly create and validate the XML documents.

### SUMMARY OF THE INVENTION

Briefly, in accordance with the present invention, a method is provided for creating an XML document that conforms to an XML schema. According to the method, while executing in a runtime environment, an XML schema is received. The XML schema has at least one top-level definition that has a content model that has at least one of a top level element declaration and a top level type definition. While executing in the runtime environment, a data structure is created that includes at least one object that corresponds to at least one sub-element of the at least one of a sub-definition and a sub-declaration of the at least one top-level definition, and the at least one object is accessed. While executing in the runtime environment, an XML document is produced that contains data stored in the data structure. The XML document conforms to the content model.

In another aspect of the present invention, an automated XML document generator is provided for creating an XML document that conforms to an XML schema. The automated XML document generator includes an XML schema receiver that receives, while executing in a runtime environment, an XML schema. The XML schema has at least one top-level definition comprising a content model that comprises at least one of a top level element declaration and a top level type definition. The automated XML document generator also includes an API class generator, communicatively coupled to the XML schema receiver, that creates, while executing in the runtime environment, a data structure that includes at least one object that corresponds to at least one of a sub-definition and a sub-declaration of the at least one top-level definition. The automated XML document generator also includes an application program, communicatively coupled to the API class generator, for accessing, while executing in the runtime environment, the at least one object. The automated XML document generator also includes an XML document producer, communicatively coupled to the API class generator, that produces, while executing in the runtime environment, an XML document that contains data stored in the data structure. The XML document conforms to the content model.

The foregoing and other features and advantages of the present invention will be apparent from the following more particular description of the preferred embodiments of the invention, as illustrated in the accompanying drawings.

### BRIEF DESCRIPTION OF THE DRAWINGS

The subject matter which is regarded as the invention is particularly pointed out and distinctly claimed in the claims at the conclusion of the specification. The foregoing and other features and also the advantages of the invention will be apparent from the following detailed description taken in conjunction with the accompanying drawings. Additionally, the left-most digit of a reference number identifies the drawing in which the reference number first appears.

FIG. 1 is an application execution environment according to an exemplary embodiment of the present invention.

FIG. 2 is an XML data structure API class diagram according to an exemplary embodiment of the present invention.

FIG. 3 is a block diagram depicting a computer processing node as used by an exemplary embodiment of the present invention.

FIG. 4 illustrates an exemplary XML movie schema as is accepted by an exemplary embodiment of the present invention.

FIG. 5 illustrates an exemplary schema viewer graphical display as is produced by an exemplary embodiment of the present invention.

FIG. 6 illustrates an exemplary code segment as is used by an exemplary embodiment of the present invention.

FIG. 7 illustrates an exemplary XML document as is produced by an exemplary embodiment of the present invention.

FIG. 8 illustrates an exemplary choice group definition as is processed by an exemplary embodiment of the present invention.

FIG. 9 illustrates a top-level XML creation processing flow diagram in accordance with an exemplary embodiment of the present invention.

FIG. 10 illustrates a class generation processing flow diagram in accordance with an exemplary embodiment of the present invention.

FIG. 11 illustrates a create data structures processing flow diagram in accordance with an exemplary embodiment of the present invention.

FIG. 12 illustrates another exemplary XML schema as is accepted by one embodiment of the present invention.

### DETAILED DESCRIPTION OF PREFERRED EMBODIMENTS

Exemplary embodiments of the present invention provide a method and system for use with dynamic programming languages that allow efficient creation of data structures that correspond to data formats specified by content models specified within XML schemas. The data in these data structures is then able to be easily incorporated into XML documents that conform to those XML schemas. Preferred embodiments of the present invention include facilities for allowing programs written in a dynamic programming language, such as JavaScript, to create and instantiate object classes that conform to one or more pre-existing XML schemas. These object classes, which are referred to as XML data structure API classes, provide an application program interface (API) that allows application programs to manipulate data via data structures and methods that are provided by those XML data structure API classes. Once these XML data structure API classes have been instantiated, the application program is able to access data structures within those classes through conventional programming methods. The application program is able to manipulate data within those classes according to the programming specified by the application program. The classes are able to include exposed methods to facilitate access or manipulation of data according to the structures defined by the corresponding XML schema. After the application program has completed manipulation of data within the instantiated data classes, the data is then produced as an XML document that conforms to the XML schema.

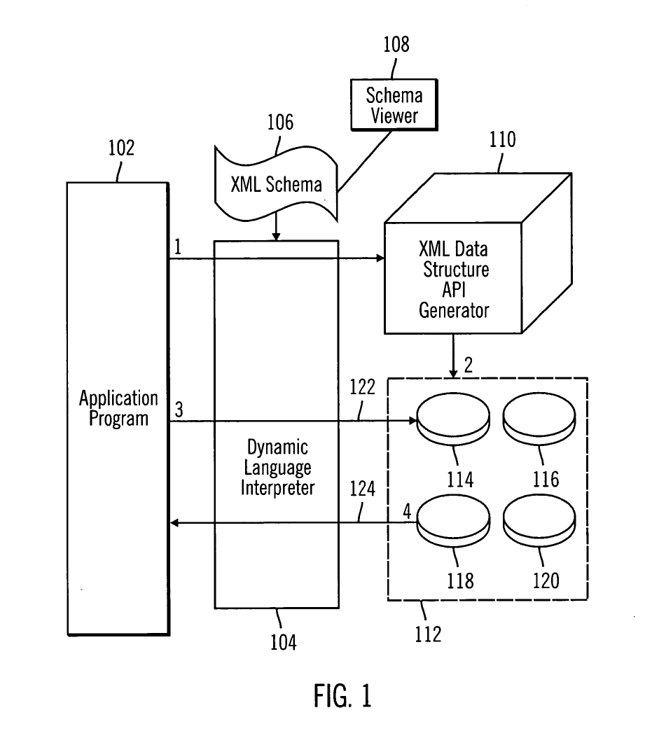

An application execution environment 100 according to an exemplary embodiment of the present invention is illustrated in FIG. 1. The application execution environment 100 includes an exemplary application program 102. The application program 102 of the exemplary embodiment is a JavaScript program. A JavaScript program, such as application program 102, is directly interpreted and executed at runtime by a dynamic language interpreter 104. The advantages of runtime interpretation of such application programs that are developed using dynamic programming languages, such as JavaScript, are well known. Advantages of using dynamic programming languages include faster development cycles, computing platform independence and ease of program modification and maintenance. The operation of the exemplary application program 102 and the dynamic language interpreter 104 are described in detail below.

The exemplary application execution environment 100 stores one or more XML schemas 106. The XML schemas 106 of the exemplary embodiment are pre-defined and define the contents and optionally the structure of XML documents that are to contain data produced by the application program 102. The structure of the XML documents is defined by a content model. The exemplary application execution environment 100 includes a schema viewer 108 to graphically represent to a software developer the data structure defined by a selected XML schema. The schema viewer is used by a software developer in the development of the application program 102 since the application program 102 of the exemplary embodiment is coded with knowledge of the structure of data class objects that are created and instantiated during the execution of the application program 102.

The exemplary application execution environment 100 also includes an XML data structure API generator 110. The application program 102 is able to create and instantiate XML data structure API classes that conform to one or more XML schema 106. The custom API generator 110 of the exemplary embodiment is a runtime object that is accessible by, or made a part of, the Dynamic Language Interpreter 104. The dynamic language interpreter 104 is made available to interpreted programs, such as the application program 102. Programmatic statements within application program 102 activate the XML data structure API generator 110 of the exemplary embodiment. In particular, the application program calls a method of the XML data structure API generator 110 with a specification of one or more XML schema 106. The XML data structure API generator 110 receives the XML schema 106 via an XML schema receiver that is a part of this method's definition. The XML data structure API generator 110 then creates XML data structure API classes that correspond to content models within the specified XML schema 106. Further method calls from within the application program 102 instantiate instances of these created class objects. The exemplary application execution environment 100 further includes a class object storage 112 to store instantiated XML data structure API classes, such as class object A 114, class object B 116, class object C 118 and class object D 120. The exemplary embodiment of the present invention allows multiple XML data structure API class definitions to be created where each class definition is based upon a different XML schema or a different combination of XML schemas. The class object storage 112 is able to store one or more instances of each of these different classes.

Once instances of the created XML data structure API classes have been instantiated, the application program 102 of the exemplary embodiment is able to manipulate data within these instantiated class objects. The application program 102 has object manipulation interfaces 122 that consist of exposed data structures and data manipulation and status reporting methods provided by the created class objects. Once the application program 102 has manipulated data within instantiated object classes, the application program 102 is able to receive an XML document that is properly structured to conform to the XML schema that was used to create the corresponding object class. These XML documents are produced by an XML document producer within the XML data structure API class and are received by the application program, or other specified destination, over an XML document interface 124.

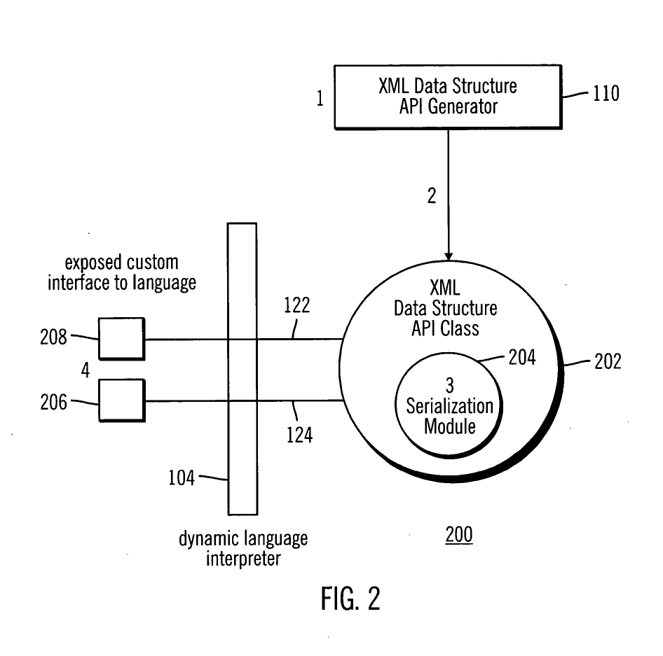

An XML data structure API class diagram 200 according to an exemplary embodiment of the present invention is illustrated in FIG. 2. The XML data structure API class diagram 200 illustrates an exemplary XML data structure API class 202 that has been created by an XML data structure API generator 110. The XML data structure API class 202 includes a parsed XML data structure description used to support subsequent processing by the generated classes. The exemplary XML data structure API class 202 also includes an object manipulation interface 122 and an XML document interface 124. An application program 102 accesses these interfaces through the dynamic language interpreter 104. Each of these interfaces is able to include one or more interface functions or data structure accesses that implement exposed interface functions.

The XML data structure API class 202 of the exemplary embodiment operates to conserve computing resources by internally instantiating and maintaining data objects within the XML data structure API class only as they are needed. Although a complete type definition is created that corresponds to the XML schema 106 from which the XML data structure API class 202 was created, instances of this class only consume storage space for data objects that have been assigned values by the application program 102. The application program 102 has no restraints on the order in which data objects within an XML data structure API class are assigned values or manipulated. The conventional data storage processing for dynamic languages, such as the JavaScript dynamic language interpreter 104 of the exemplary embodiment, does not natively store newly instantiated sub-objects in a defined order. The XML data structure API class 202 further includes a serialization module 204 in order to ensure that XML documents produced by the XML data structure API class 202 have the proper data structure. The serialization module 204 performs the processing and data maintenance required to ensure the proper order and structure of XML documents that are ultimately produced by this XML data structure API class 202 through the XML document interface 124.

Serialization of the objects within an XML data structure API class is performed by one of several methods. The target dynamic language typically has standard deserialization mechanisms (i.e., JavaScript uses the toString conversion). Deserialization of data within an XML data structure API class is also able to be triggered by a method exposed by the class itself. For instance, a SerializeSchemaObject( ) method can be exposed at the top-level or even for each sub-object within the XML data structure API class. Once serialization is invoked, such as preceding the production of an XML document for output, the XML data structure API class object goes through its sub-objects. If a sub-object is a simple type, that is, is not another API class object, the serialization processing retrieves the value for that object and outputs the value into an XML document enclosed within an appropriate XML tag. If a sub-object is part of a choice group, as is described further below, then the object that corresponds to the choice that was selected by the previous processing of the application program 102 is serialized. If a sub-object represents another XML data structure API class object, then the serialization of that object is recursively invoked. The iteration of sub-objects is performed in the order specified by the parsed XML schema description data structure that is associated with this XML data structure API object in order to ensure conformity with the data element order specified in the XML schemas. The parsed XML schema description data structure associated with the XML data structure API object is also used in the exemplary embodiment to insure proper serialization with respect to other XML constructs, such as namespaces and ‘nil’ elements. This processing further ensures that the ‘xsi:type’ attribute is added into the XML document where appropriate.

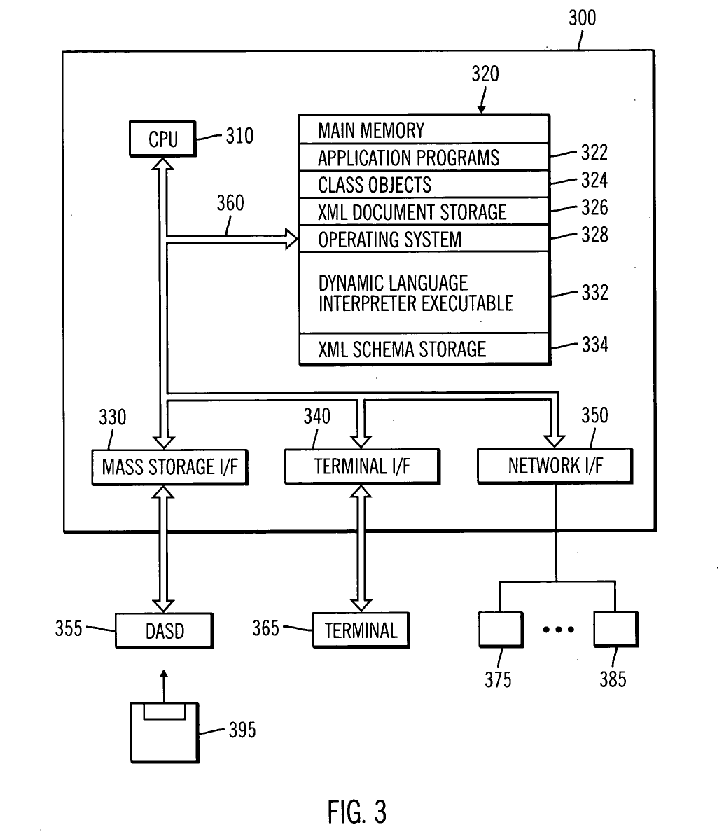

A block diagram depicting a computing node 300 as used by an exemplary embodiment of the present invention is illustrated in FIG. 3. Any suitably configured processing system is also able to be used in further embodiments of the present invention. The computer system 300 has a processor 310 that is connected to a main memory 320, mass storage interface 330, terminal interface 340 and network interface 350. A system bus 360 interconnects these system components. Mass storage interface 330 is used to connect mass storage devices, such as DASD device 355, to the computer system 300. One specific type of DASD device is a floppy disk drive, which may be used to store data to and read data from a floppy diskette 395.

The main memory 320 of the exemplary embodiment contains several components. Main memory 320 contains application programs 322 that include the exemplary application program 102 and other application programs executed by the computer system. Main memory 320 also includes objects 324 that include instantiated objects, such as instantiated XML data structure API classes stored in the class object storage 112. Main memory 320 also contains data 326 that includes XML documents produced by the XML data structure API class instances. Main memory 320 further has an operating system image 328.

The main memory 320 of the exemplary computing node 300 also contains executable software for a dynamic language interpreter 332. The dynamic language interpreter executable software 332 implements the exemplary JavaScript dynamic language interpreter 104. The main memory 320 of the exemplary computing node 300 further includes a XML schema storage 334 that is used to store pre-defined XML schemas, such as the exemplary XML schema 106.

Although illustrated as concurrently resident in main memory 320, it is clear that the application programs 322, objects 324, data 326 and operating system 328 are not required to be completely resident in the main memory 320 at all times or even at the same time. Computer system 300 utilizes conventional virtual addressing mechanisms to allow programs to behave as if they have access to a large, single storage entity, referred to herein as a computer system memory, instead of access to multiple, smaller storage entities such as main memory 320 and DASD device 355. The term “computer system memory” is used herein to generically refer to the entire virtual memory of computer system 300.

Operating system 328 is a suitable multitasking operating system. Operating system 328 includes a DASD management user interface program to manage access through the mass storage interface 330. Some embodiments of the present invention utilize architectures, such as an object oriented framework mechanism, that allow instructions of the components of operating system 328 to be executed on any processor within computer 300.

Although only one CPU 302 is illustrated for computer 302, computer systems with multiple CPUs can be used equally effectively. Such embodiments of the present invention incorporate interfaces that each includes separate, fully programmed microprocessors that are used to off-load processing from the CPU 302. Terminal interface 308 is used to directly connect one or more terminals 318 to computer system 300. These terminals 318, which are able to be non-intelligent or fully programmable workstations, are used to allow system administrators and users to communicate with computer system 300.

Network interface 350 is used to connect other computer systems or group members, e.g., Station A 375 and Station B 385, to computer system 300. The present invention works with any data communications connections including present day analog and/or digital techniques or via a future networking mechanism.

Although the exemplary embodiments of the present invention are described in the context of a fully functional computer system, further embodiments are capable of being distributed as a program product via floppy disk, e.g. floppy disk 395, CD-ROM, or other form of recordable media, or via any type of electronic transmission mechanism.

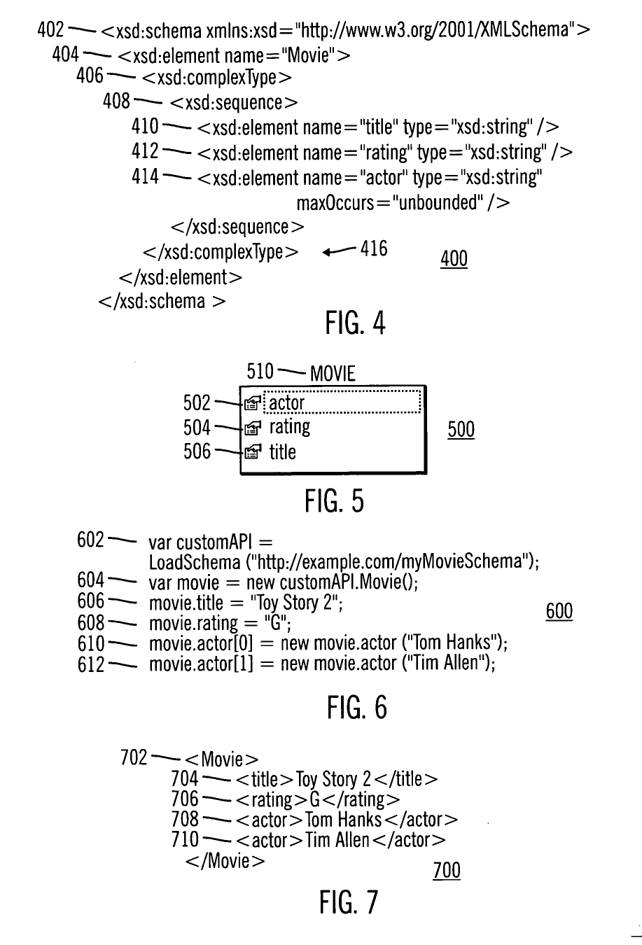

An exemplary XML movie schema 400 as is accepted by an exemplary embodiment of the present invention is illustrated in FIG. 4. The exemplary XML movies schema 400 defines a data structure, which is an example of a content model, that contains data about movies. The exemplary XML movie schema 400 defines structures and elements contained within XML instance documents that contain specific data about individual movies.

The exemplary XML schema 400 includes a conventional schema header 402 that is used by this schema. A top-level element declaration 404 is included to identify this element with the name “Movie.” The movie element has a complexType attribute 406 that indicates that this element consists of further XML descriptions and is not a simple data type, such as an integer or string. The movie element further has a sequence attribute 408 that specifies that the specified sub-elements are to be provided in the specified sequence.

The movie element is shown to include three sub-elements. A “title” element declaration 410 defines the title sub-element as a string. A “rating” element declaration 412 similarly defines the rating sub-element as a string. The “actor” element declaration 414 defines actor sub-elements as strings. The “maxOccurs=unbounded” attribute of the “actor” element declaration 414 indicates that an unbounded number of these sub-elements can occur within a movie element. These definitions are then terminated by terminating tags 416.

An exemplary schema viewer graphical display 500 as produced by the exemplary schema viewer 108 for the exemplary XML movie schema 400 is illustrated in FIG. 5. This graphical display is used by software developers who are creating application programs in order to determine the structure and element names defined by a particular XML schema. Application programs operate with XML data generator API objects to manipulate data structures that reflect the structure of XML schemas. Application programs access these data structures by accessing data objects that have names that correspond to the element names defined within the XML schema from which the XML data structure API class is generated. The exemplary Schema Viewer graphical display 500 allows the application program developer to identify the element names and the relative structure of these elements within the XML schema. More complex XML schemas include hierarchical data structures with one or more layers of sub-elements. This hierarchical data structure is illustrated in the exemplary schema viewer graphical display 500 produced by the exemplary schema viewer 108.

The exemplary schema viewer graphical display 500 has a title 510 that shows the illustrated top-level element of the XML structure is called “Movie.” The Movie top-level element is shown to have three sub-element declarations. The “actor” sub-element 502 corresponds to the “actor” element declaration 414. The “rating” sub-element 504 corresponds to the “rating” element declaration 412. The “title” sub-element 506 corresponds to the “title” element declaration 410.

The XML schema viewer 500 is used to provide automatic generation of documentation for use in coding application programs that use generated XML data structure API classes. The XML schema viewer 500 is able to generate this documentation in the form of a syntax assistance database so that the application program developer is able to refer to this syntax assistance data during the application program development.

An exemplary code segment 600 as is included in the application program 102 of the exemplary embodiment of the present invention is illustrated in FIG. 6. The exemplary code segment 600 is a JavaScript application program that is interpreted by the dynamic program interpreter 104 of the exemplary embodiment. The exemplary code segment 600 starts with a program command to the XML data structure API generator 110 to generate an XML data structure API class based upon the schema located at http://example.com/myMovieSchema. This LoadSchema command 602 causes the XML data structure API generator 110 to generate an XML data structure API class that corresponds to the specified XML schema. This generated class is pointed to by the variable customAPI. The XML data structure API class generated by the exemplary embodiment has an exposed constructor for each top-level element defined within the specified XML schema.

The exemplary code segment 600 then has a class instance instantiation command 604 that executes a “Movie” constructor of the generated XML data structure API class in order to create an instance of an XML data structure API class that corresponds to the “movie” top-level element of the loaded XML schema 400. This instance is referenced in this example by the “movie” variable. When a constructor in the exemplary embodiment is invoked, the constructor traverses the content model as defined by the specified XML schema of the top-level element or top-level type to which the constructor corresponds. An XML schema content model consists of one or more of named-elements, wildcard-elements, all-groups, sequence-groups, and choice-groups. Each group within a content model is in turn able to recursively contain other groups or elements. An object constructor creates a class object that exposes every element in the content model as a property of that class object. Named objects in the exemplary embodiment are exposed using the name given for the corresponding element in the specified XML schema.

The class object exposes data structures that describe the content model of an element or a type. When the application program 102 invokes a constructor for a class, the constructor creates a class object that holds the element or type. This object has a name corresponding to the name of the element and also has a list of sub-objects. Each sub-object describes either an item from the element's content model or an attribute. The constructor then iterates through the description of the content model. For each element, wildcard, attribute, or model group, as appropriate, it creates a sub-object. For schema items in the content model with maxOccurs set to a value greater than one, two sub-objects instead of one are created in the exemplary embodiment. A first sub-object is an array sub-objects that holds instances of the item. A second sub-object is a constructor that the application program 102 executes to create instances of this object. This constructor works the same as the constructor being invoked, but uses a different schema description data structure, namely the one for the appropriate element or type corresponding to the item. Once the constructor has generated the complete API object, it is returned to the application program 102. The application program 102 then manipulates the sub-objects directly as it would a native data structure.

Subsequent programming commands in the exemplary code segment 600 load data into the data sub-objects of the “movie” data structure within the instantiated XML data structure API class object. The “title” data sub-object within the XML data structure API class object is loaded with the string “Toy Story 2” in this example with a title sub-object assignment 606. This sub-object corresponds to the title element defined by the “title” element declaration 410 in this example. The “rating” data sub-object within the XML data structure API class object is loaded with the string “G” in this example with a ratings sub-object assignment 608. This sub-object corresponds to the rating element defined by the “rating” element declaration 412 in this example.

The exemplary code segment 600 then creates two instances of the “actor” sub-object. The “actor” element defined by the “actor” element declaration 414 of the exemplary XML schema 400 specifies that this element can occur an unbounded number of times. Since this is greater than one, two sub-objects are created, an array and a constructor, as is described above. The exemplary embodiment of the present invention accesses the multiple instances of this sub-element through the array nomenclature. A first “actor” sub-object assignment 610 creates a first actor sub-object by executing the constructor “movie.actor(“Tom Hanks”)” with the “new” keyword. The corresponding first actor sub-object within the data structure of the XML data structure API class is identified as the first element of the array with the first element notation “[0].” A second “actor” sub-object assignment 612 similarly executes the same constructor to create a second actor sub-object. The corresponding sub-object of the data structure is identified with the second element notation “[1].” This programming notation is implemented by an extension to the dynamic language interpreter 104 to allow straightforward access to data structure objects that correspond to hierarchical data structures specified by XML schemas while retaining data structure access syntax used by the dynamic language and familiar to application programmers.

An exemplary XML document 700 as produced by the data manipulation performed by the exemplary code segment 600 in accordance with an exemplary embodiment of the present invention is illustrated in FIG. 7. The exemplary XML document is produced by the XML data structure API class instance after the data manipulation described for the exemplary code segment 600. The exemplary XML document starts with a “Movie” tag 702 that indicates that the data within this element conforms to the “Movie” element defined in the exemplary XML schema 400. The movie element is shown to have four sub-elements. These four sub-elements conform to the sub-element sequence that was defined in the exemplary XML schema, which is discussed above.

The Movie element of the exemplary XML document 700 has a title element 704 with the string “Toy Story 2.” This element was loaded by the title sub-object assignment 606, discussed above. A rating sub-element 706 is shown to contain the string “G” as was loaded by the rating sub-element assignment 608, discussed above. Two actor sub-elements are shown, in accordance with the two actor sub-object assignments of the exemplary code segment 600, as are discussed above. The first actor sub-element 708 has the string “Tom Hanks” and the second actor sub-element 710 has the string “Tim Allen.”

Preferred embodiments of the present invention advantageously provide easy manipulation within dynamic languages of data structures that reflect the structure of content models defined by XML schemas. The APIs exposed by the XML data structure API classes in the preferred embodiments behave very much like a native data structure of the target language. This contrasts with procedures using conventional API generation approaches, such as generating source code in the target language, which is difficult for dynamic languages such as JavaScript. Preferred embodiments of the present invention advantageously merge API generation and serialization into the dynamic language's runtime. This merger is achieved by placing the API generation process and the objects it generates directly into the dynamic language runtime. This allows the generated API objects to expose interfaces and behavior mimicking the normal native data structures in the dynamic language while allowing manipulation of internal data structures that contain XML data. Although the data structures and XML documents are created at runtime, documentation, such as syntax assistance produced by the XML schema viewer is able to be generated statically to help with development. Some embodiments of the present invention further create intermediate files to allow for enhanced implementation efficiency. For example, an XML schema is able to be canonicalized, otherwise manipulated, or “compiled” into a more efficient format for processing prior to runtime and the canonicalized results are stored for later use at runtime. Integration with the dynamic language interpreter 104 is achieved in various embodiments of the present invention by modifying the runtime itself or by using hooks provided for integration by the runtime. Examples of such integration hooks include the IDispatch and IDispatchEx functionality of the Microsoft JScript runtime.

Most XML schema element declarations and attributes are able to be directly reflected in the data structure exposed for the XML data structure API class. The exemplary embodiment of the present invention accommodates some constructs for XML schemas by using special nomenclature syntax for exposed data and/or methods that correspond to these constructs. For example, attributes and elements in XML schemas are allowed to have the same name. Naming conflicts are resolved between attributes of an element and sub-elements of that element in one of several ways. Some embodiments of the present invention precede attributes with a special character, such as the @ symbol as is used by the XPath standard, to disambiguate attributes and sub-elements. Other embodiments of the present invention expose attributes and sub-elements via different mechanisms. For example, JavaScript allows properties to be used as both standard properties that access and set a value as well as a method. Therefore, attributes and sub-elements can be distinguished by exposing attributes via using an element property as a method and sub-elements when it is used as a traditional property.

Wildcard elements in the exemplary embodiment are exposed as a special property. In an XML schema content model, wildcard elements represent a content model that allows elements of any name to exist (with appropriate namespace constraints given in the XML schema). That property is given a generated name in the exemplary embodiment in order to expose that property to the dynamic language. One example of such a generated name is $any or $any1. The identifier $any contains a $ symbol since that symbol is valid for identifiers in JavaScript and is not valid for element names in XML. This avoids naming conflicts with properly named elements within the XML schema. Multiple wildcard-elements that exist at the same level in a content model are accommodated by creating multiple properties to represent the wildcard elements. Procedures are used to ensure that properties do not share the same name.

XML schemas allow groups of elements to be separately repeated. XML schemas express this characteristic by the minOccurs and maxOccurs attributes of the content model group constructs such as “sequence” and “choice”. Normally, grouping constructs such as “sequence” and “choice” are not required to be exposed or even incorporated into an XML data structure API class. In the case of an element of a content model group that has a maxOccurs attribute greater than one, the exemplary embodiment of the present invention exposes this as if it were a sub-element. This is achieved as with wildcard elements by exposing the content model group as a “$sequence” property, or “$all” property, or “$choice” property, as appropriate. These properties behave like an API object that is generated for arrays of elements.

Choice groups are also treated specially by the exemplary embodiment of the present invention. A choice group in an XML schema specifies that an XML instance document is able to contain at most one of the particles within the choice group. A particle is able to be an element or another model group. Choice groups are able to be exposed to the generated API in order to remove ambiguity in certain cases, such as when a particle of at least one choice is the same as that of a subsequent choice group in the same content model.

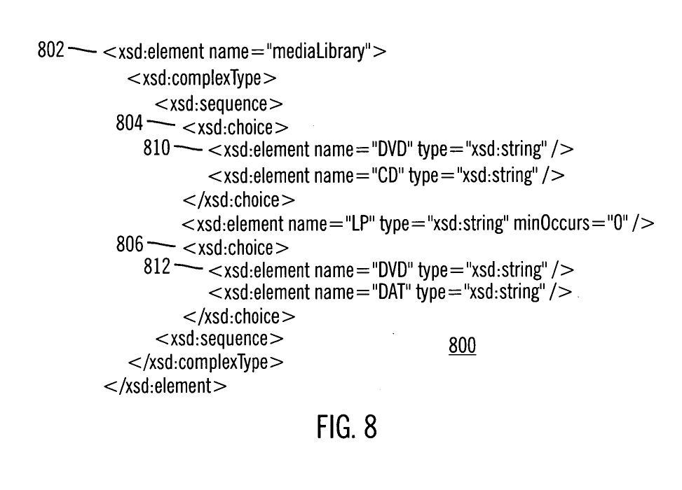

An exemplary choice group definition 800 as is processed by an exemplary embodiment of the present invention is illustrated in FIG. 8. The exemplary choice group definition 800 includes a first choice group demarcated by a first choice tag 804 and a second choice group demarcated by a second choice tag 806. Exposed data structures for an XML data structure API class that corresponds to an XML schema that includes the exemplary choice group definition 800 use methods to disambiguate between a first “DVD” element 810 that is in the first choice group and a second “DVD” element 812 that is in the second choice group. The exemplary embodiment of the present invention resolves this ambiguity by altering the name of the “DVD” property exposed by the XML data structure API class, such as modifying the name to “DVD1” and “DVD2.” Other embodiments of the present invention resolve this ambiguity by exposing the choice group in the generated XML data structure API class, such as via a “$choice” property. Such embodiments have two choices at the same level in the content model and thereby have mechanisms to resolve the ambiguity between the different choice groups. Such mechanisms include altering the name, such as using “$choice1” and “$choice2,” or by making the choice property a prepopulated array such as “$choice[0]” and “$choice[1].” In a case where the choice groups have maxOccurs set to a value greater than one in the XML schema, the ambiguity between instances is resolved using techniques similar to those described above. In the example of an array solution, the $choice object becomes a two-dimensional array.

Another area of special processing for XML element declaration involves case-sensitivity of the target language. Since XML is case-sensitive, interfaces used by target languages that are not case-sensitive require resolution of ambiguity between different elements that are defined in an XML schema that differ only by case. Similar accommodations are made in the exemplary embodiment of the present invention when using a target language that assigns particular meanings to the case of text. The exemplary embodiment of the present invention uses an isomorphic transformation for XML tag names into identifiers in the target language. The transformation is able to be stateful, such as altering names with a digit suffix to resolve ambiguities in certain cases.

Another accommodation incorporated in the exemplary embodiment of the present invention involves the idea of namespace in XML. Because of XML namespaces, a content model is able to share multiple elements that have the same name but are qualified by different namespaces. The exemplary embodiment of the present invention resolves such ambiguities by methods similar to those described above.

The XML data structure API class of the exemplary embodiment is also able to incorporate runtime error checking for access to the data structures that are exposed by the XML data structure API class. Such runtime error checking includes preventing the developer from erroneously creating or attempting to manipulate data in an XML document that does not properly conform to the specified XML schema. This error checking is performed by mirroring the structure of the XML document in the XML data structure API class itself, as well as by runtime checks that are performed during execution of the XML data structure API class. For example, if a developer misspells the name of an element, such as the “title” element 410, conventional APIS, such as the DOM API, would not raise an error. However, if the developer misspells ‘title’ in the exemplary title assignment statement 606, the XML data structure API class of the exemplary embodiment raises an error. The XML data structure API class is able to perform this runtime error processing because the contents of the XML schema are available to this processing and misspelling of data structure names, as well as accessing any non-existent element, is able to be identified. Similar runtime error checking includes verifying the ordering of sub-elements, such as the sub-elements of the ‘movie’ element in the exemplary XML schema 400. In the exemplary XML schema 400, the ‘title’, ‘rating’, and ‘actor’ elements are required to appear in exactly the specified order in a conforming document. Using conventional APIs, such as the DOM API, an error is not raised if the developer added sub-elements in an incorrect order. However, the exemplary embodiment generates XML data structure API classes that have access to the XML schema and are able to automatically serialize data into XML documents in the proper order, regardless of the order in which the developer fills in the data in the application program.

The XML data structure API class is also able to provide data verification to the extent data elements are specified in the XML schema. XML schemas are able to provide guidelines for content of XML documents that can be more stringent than just the structure of the document, such as element names and hierarchy. XML data structure API classes are able to perform further validation based upon these specifications. For instance, an XML schema can specify that a hypothetical ‘phoneNumber’ element must contain exactly 10 numerical digits. The XML data structure API class generated from the XML schema is then able to ensure that values given to the ‘phoneNumber’ element conform to this specification. Similar validation is able to be performed for arrays. For example, an XML schema can specify that an array of elements must have a particular number of elements. The XML data structure API class objects can raise errors if a minimum number of elements in the array is not met and/or the maximum number of elements in the array is exceeded. The XML data structure API class objects are able to perform such validation either as the object is being used by the application program, or the object can defer validation until serialization time when the XML document is ultimately produced for output.

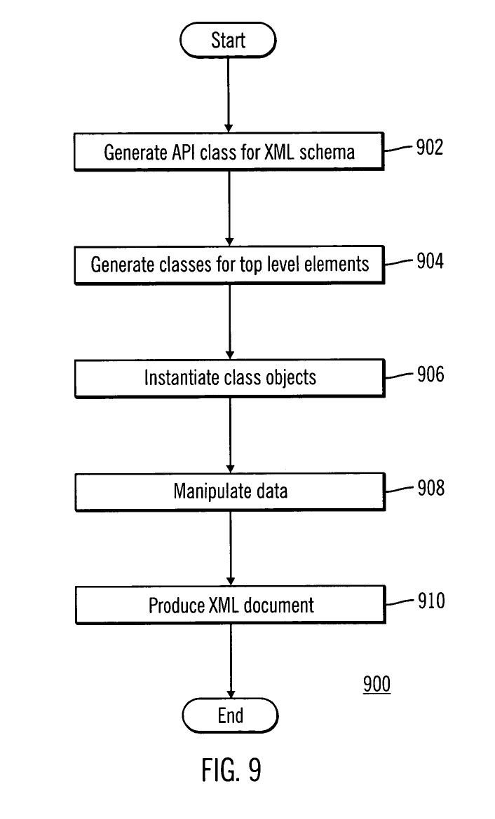

A top-level XML creation processing flow 900 diagram as is performed by an exemplary embodiment of the present invention is illustrated in FIG. 9. The top-level XML creation processing flow 900 is performed by the computing node of the exemplary embodiment when executing an application program 102 to create an XML instance document that contains data in a format specified by a specified XML schema. The top-level XML creation processing flow 900 begins by generating, at step 902, an XML data structure API class for a specified schema. This is performed in the exemplary embodiment by providing a selected XML schema along with a call to a constructor within the XML data structure API generator 110. The processing of the exemplary embodiment then generates, at step 904, an object class for each top-level definition within the specified XML schema. The processing then advances to instantiating, at step 906, a class object for the XML data structure API class generated above. The class object is instantiated by processing specified in the application program 102 of the exemplary embodiment.

After a class object is instantiated, the application program of the exemplary embodiment manipulates, at step 908, data within the object class. Application program 102 manipulates data by accessing exposed data and methods of the class object. After the data in the class object has been manipulated according to the processing specified by the application program 102, an XML instance document is produced, at step 910. The processing then terminates.

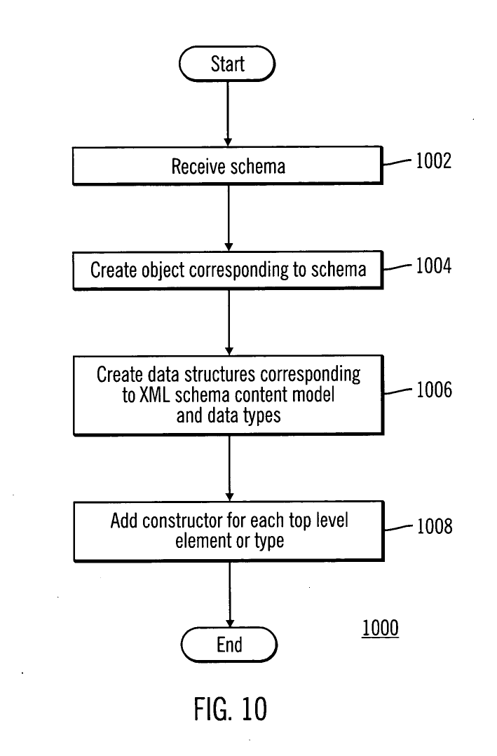

A class generation processing flow diagram 1000 as performed by an exemplary embodiment of the present invention is illustrated in FIG. 10. The class generation processing flow diagram 1000 is an implementation of the generate classes step 904 described above. The class generation processing flow diagram 1000 begins by receiving, at step 1002, an XML schema that was specified by the application program 102. The processing then creates, at step 1004, an object that corresponds to the received schema. The processing then creates, at step 1006, data structures that correspond to XML schema content model and types. Constructors are then added, at step 1008, for each top-level element or type within the received XML schema.

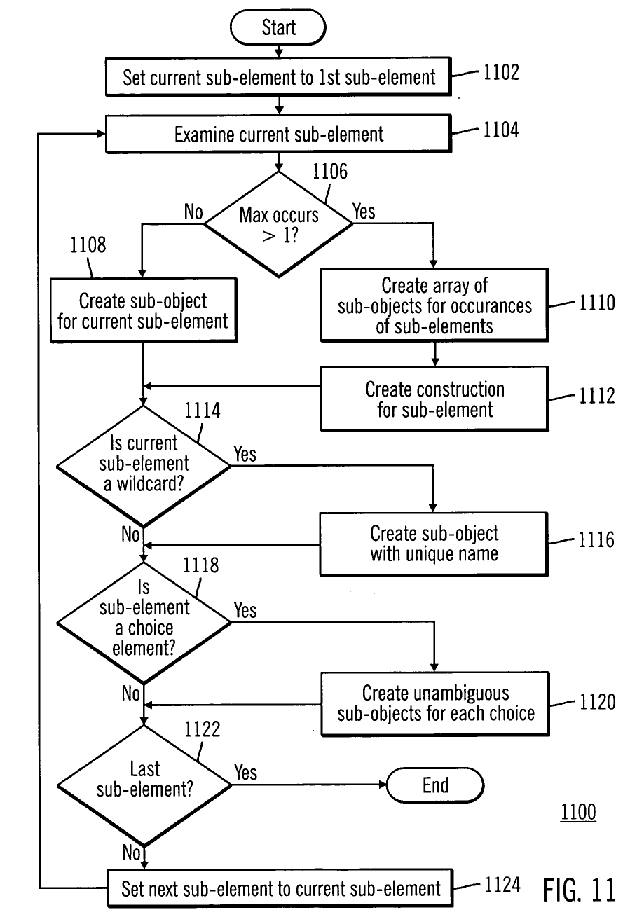

A create data structures processing flow diagram 1100 as is performed by an exemplary embodiment of the present invention is illustrated in FIG. 11. The create data structures processing flow diagram 1100 is an implementation of the create data structures corresponding to XML schema content model and types step 1006 described above. The create data structures processing flow diagram 1100 begins by setting, at step 1102, a current sub-element to the first sub-element for a top-level element or type. The processing then examines, at step 1104, the current sub-element. The processing proceeds to determine, at step 1106, if the maxOccurs for the current sub-element is greater than one.

If the maxOccurs for the current sub-element is determined to not be greater than one, the processing proceeds to create, at step 1108, a sub-object within the class object for the current sub-element. If the maxOccurs for the current sub-element is determined to be greater than one, the processing advances to create, at step 1110, an array of sub-objects for the multiple occurrences of the current sub-element. The processing then continues to create, at step 1112, a constructor for the current sub-element that will construct new sub-objects within the object class being generated.

After either creating a sub-object for the current element or creating a constructor for the current sub-element, the processing continues by determining, at step 1114, if the current sub-element is a wild-card element. If the current sub-element is determined to be a wild-card element, the processing creates a sub-object with a unique name for the current sub-element, as is described above.

The processing then proceeds by determining, at step 1118, if the current sub-element is a choice element. If the current sub-element is determined to be a choice element, the processing creates, at step 1120, unambiguous sub-objects for each choice, as is described herein.

The processing next determines, at step 1122, if the current sub-element is the last sub-element for this top-level element within the received XML schema. If the current sub-element is determined to be the last sub-element, the processing terminates. If the current sub-element is determined to not be the last sub-element, the processing sets, at step 1124, the next sub-element to be the current sub-element. The processing then returns to examining, at step 1104, the current sub-element and continues as described above.

The XML data structure API classes are dynamically generated by the exemplary embodiment. This is in contrast to conventional systems that statically generate APIs for XML documents. The exemplary embodiment of the present invention advantageously obviates the need to generate a file or sets of files in order to implement the API to the XML data. The XML data structure API class generation in the exemplary embodiment of the present invention is part of the execution of the application program 102 in order to provide an integrated API that is able to operate with dynamic languages.

The processing described above for the generation and use of the XML data structure API class all occurs in the exemplary embodiment while the application program is running. None of the XML data structure API class processing, aside from XML schema definition, that is described above occurs at development time. The operation of the exemplary embodiment compares favorably to conventional systems, which are intended to be used with non-dynamic languages. Such conventional systems generate API classes by creating static files that are used by the non-dynamic language's compiler. Such approaches are not available in dynamic, untyped languages, such as JavaScript, where one cannot create a static file to define data structures with serialization semantics. The exemplary embodiment of the present invention creates API classes at runtime for immediate use by an application program, without a need for static files. This results in the exemplary embodiment of the present invention being advantageously suited for use with dynamic, untyped languages, such as JavaScript.

The embodiments described above create sub-objects for instantiated XML data structure API classes in a lazy or deferred manner, i.e., as the data is loaded into those structures. Alternative embodiments of the present invention use a more active approach and create sub-objects at different times during execution.

Additionally, the above discussion describes the creation of an XML instance document that conforms to a particular XML schema. Furthermore, embodiments of the present invention operate to deserialize, or parse, XML instance documents that conform to a particular XML schema. These embodiments invoke a class object generator with the two arguments instead of the one argument, as described for the above embodiments. A first argument in deserializing or parsing embodiments is an XML schema, as was already discussed. A second argument is an XML instance document. The class object generator then performs similar steps to those described above to generate the API for use by the application program. The deserializing or parsing embodiments, however, fill in the sub-objects of the generated class object as they are generated with values that are taken from the XML instance document. The filled data structure constructed for API object is then returned to the client code.

Although the above description relates to XML schemas that define top-level elements, preferred embodiments of the present invention can process XML schemas that contain both top level element declarations and top level type definitions. Top level type definitions are essentially equivalent to top level element declarations and are able to contain sub-declarations. For example, both can define a content model. However, a top level type definition defines the content model and not the name of the XML tag that is to be used in serializing that content model. A top level type definition can be described as an element declaration without an element name having been defined. Thus, a special consideration is made for the classes that are generated that represent top level type definitions instead of top level documents. These classes have an internal data variable to store the name of the XML element used in serialization of the content model. This name is then provided at some point by the application program. The name is able to be provided implicitly by its context and usage in the application program or explicitly via a public method or property exposed by the generated class. One important use for top level type definitions is for serializing elements whose content model is semantically inherited from another content model. This is a consideration with content models that are defined as ‘abstract’ in an XML Schema. Such elements enforce that instances of the element are not valid unless the content model is extended.

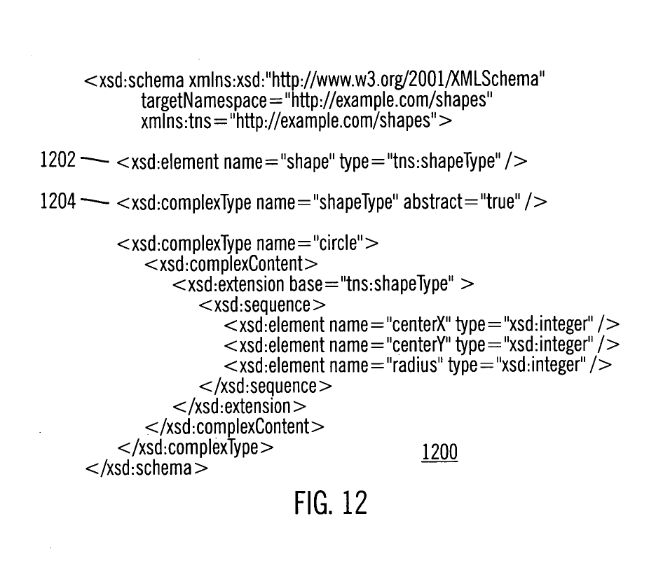

An exemplary XML schema 1200 that includes top level type definitions as accepted by one embodiment of the present invention is illustrated in FIG. 12. In this exemplary XML schema, the ‘shape’ element 1202 cannot be part of a valid XML document conforming to this schema unless it is explicitly noted that its content model is derived from the ‘shapeType’ type definition 1204. This restriction is due to the fact that the ‘shapeType’ is marked as an ‘abstract’ type in the ‘shapeType’ type definition 1204. In this embodiment, API classes and constructors are generated for the ‘shape’ element and the ‘shapeType’ and the ‘circle’ type using the algorithms previously discussed. However, these instances of a ‘shape’ class and a ‘shapeType’ class cannot be serialized on their own. Instead, an application program instantiates a class of a derived type, such as the ‘circle’ type. The application then supplies that instance of the derived type class to the ‘shape’ API class instance. Upon doing so, the system marks that the ‘circle’ type's class will be serialized with the element name of ‘shape’ and with the appropriate ‘xsi:type’ attribute to specify the derived type in use. This and similar techniques generally allow top level type definition API class instances to be used in conjunction with other elements or such classes. In order to allow such structures to be serialized independently of other elements, a name of a wrapper XML element is then defined in this embodiment.

Further, while the embodiment of the present invention described above use XML Schema as defined by the W3C, further embodiments incorporate XML schemas in the general sense of constraining the structure of an XML document. Such embodiments utilize other forms of schemas that are defined for XML and differ in syntax and feature set. Although some of the features of the embodiments described above may be specific to W3C type XML Schemas, further embodiments of the present invention utilize other schema languages, such as Document Type Definitions (DTDs) or RelaxNG, with similar effectiveness.

Embodiments of the invention can be implemented as a program product for use with a computer system such as the computing node shown in FIG. 3 and described herein. The program(s) of the program product defines functions of the embodiments (including the methods described herein) and can be contained on a variety of signal-bearing medium. Illustrative signal-bearing medium include, but are not limited to: (i) information permanently stored on non-writable storage medium (e.g., read-only memory devices within a computer such as CD-ROM disk readable by a CD-ROM drive); (ii) alterable information stored on writable storage medium (e.g., floppy disks within a diskette drive or hard-disk drive); or (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the present invention, whether implemented as part of an operating system or a specific application, component, program, module, object or sequence of instructions may be referred to herein as a “program.” The computer program typically is comprised of a multitude of instructions that will be translated by the native computer into a machine-readable format and hence executable instructions. Also, programs are comprised of variables and data structures that either reside locally to the program or are found in memory or on storage devices. In addition, various programs described herein may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

It is also clear that given the typically endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.) It should be appreciated that the invention is not limited to the specific organization and allocation or program functionality described herein.

The present invention can be realized in hardware, software, or a combination of hardware and software. A system according to a preferred embodiment of the present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general purpose computer system with a computer program that, when being loaded and executed, controls the computer system such that it carries out the methods described herein.

Each computer system may include, inter alia, one or more computers and at least a signal bearing medium allowing a computer to read data, instructions, messages or message packets, and other signal bearing information from the signal bearing medium. The signal bearing medium may include non-volatile memory, such as ROM, Flash memory, Disk drive memory, CD-ROM, and other permanent storage. Additionally, a computer medium may include, for example, volatile storage such as RAM, buffers, cache memory, and network circuits. Furthermore, the signal bearing medium may comprise signal bearing information in a transitory state medium such as a network link and/or a network interface, including a wired network or a wireless network, that allow a computer to read such signal bearing information.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

1. A method for creating an XML document that conforms to an XML schema, the method comprising the steps of:
receiving, while executing in a runtime environment, an XML schema that comprises at least one top-level definition, the at least one top-level definition comprising a content model that comprises at least one of a top level element declaration and a top level type definition;
creating, while executing in the runtime environment, a data structure that includes at least one object that corresponds to at least one of a sub-definition and a sub-declaration of the at least one top-level definition;
accessing, while executing in the runtime environment, the at least one object; and
producing, while executing in the runtime environment, an XML document that includes data stored in the data structure, the XML document conforming to the content model.

2. The method according to claim 1, further comprising the step of generating a representation of the data structure.

3. The method according to claim 1,
wherein the data structure has a structure that differs from the content model, and
the producing step comprises serializing data stored in the data structure to conform to the content model.

4. The method according to claim 1, wherein the accessing step is performed by a dynamic programming language interpreter.

5. The method according to claim 4, wherein the dynamic programming language is JavaScript.

6. The method according to claim 1, further comprising the steps of:
accepting the XML document that conforms to the XML schema; and
loading data into the at least one object from a corresponding element within the XML schema.

7. An automated XML document generator for creating an XML document that conforms to an XML schema, the automated XML document generator comprising:
an XML schema receiver receiving, while executing in a runtime environment, an XML schema that comprises at least one top-level definition comprising a content model that comprises at least one of a top level element declaration and a top level type definition;
an API class generator, communicatively coupled to the XML schema receiver, creating, while executing in the runtime environment, a data structure that includes at least one object that corresponds to at least one of a sub-definition and a sub-declaration of the at least one top-level definition;
an application program, communicatively coupled to the API class generator, accessing, while executing in the runtime environment, the at least one object; and
an XML document producer, communicatively coupled to the API class generator, producing, while executing in the runtime environment, an XML document that contains data stored in the data structure, the XML document conforming to the content model.

8. The automated XML document generator according to claim 7, further comprising an XML schema viewer generating a representation of the data structure.

9. The automated XML document generator according to claim 7,
wherein the data structure has a structure that differs from the content model, and
the XML document producer comprises a serialization module serializing data stored in the data structure to conform to the content model.

10. The automated XML document generator according to claim 7, wherein the application program is written in a dynamic programming language.

11. The automated XML document generator according to claim 10, wherein the dynamic programming language is JavaScript.

12. The automated XML document generator according to claim 7, further comprising a class object generator for:
accepting the XML document that conforms to the XML schema; and
loading data into the at least one object from a corresponding element within the XML schema.

13. A computer program product for creating an XML document that conforms to an XML schema, the computer program product comprising:
a storage medium readable by a processing circuit and storing instructions for execution by the processing circuit for performing a method comprising the steps of:
receiving, while executing in a runtime environment, an XML schema that comprises at least one top-level definition comprising a content model that comprises at least one of a top level element declaration and a top level type definition;
creating, while executing in the runtime environment, a data structure that includes at least one object that corresponds to at least one of a sub-definition and a sub-declaration of the at least one top-level definition;
accessing, while executing in the runtime environment, the at least one object; and
producing, while executing in the runtime environment, an XML document that contains data stored in the data structure, the XML document conforming to the content model.

14. The computer program product according to claim 13, wherein the method further comprises the step of generating a representation of the data structure.

15. The computer program product according to claim 14,
wherein the data structure has a structure that differs from the content model, and
the method further comprises the step of serializing data stored in the data structure to conform to the content model.

16. The computer program product according to claim 13, wherein the instructions for performing the step of accessing are written in a dynamic programming language.

17. The computer program product according to claim 16, wherein the dynamic programming language is JavaScript.

18. The computer program product according to claim 13, wherein the method further comprises the steps of:
accepting the XML document that conforms to the XML schema; and
loading data into the at least one object from a corresponding element within the XML schema.
